(19) United States
(12) Patent Application Publication
(10) Pub. No.: US 2003/0012569 A1
(43) Pub. Date: Jan. 16, 2003

(54) Pre-exposure of emulsion media with a steganographic pattern

(76) Inventors: Brian D. Lowe, St. Helens, OR (US); Tyler J. McKinley, Lake Oswego, OR (US)

Correspondence Address: DIGIMARC CORPORATION, 19801 SW 72ND AVENUE, SUITE 100, TUALATIN, OR, 97062, US

(21) Appl. No.: 10/121,435

(22) Filed: Apr. 11, 2002

Related U.S. Application Data
(60) Provisional application No. 60/284,163, filed on Apr. 16, 2001.

(51) Int. Cl. G03B 17/24

(52) U.S. Cl. 396/310

(57) ABSTRACT

Emulsion media (e.g., photographic film or paper) is pre-processed to impart a steganographic pattern to the emulsion. The pattern is manifested when the media is exposed and developed by a user, and can serve device-control or other data-conveying purposes.

### RELATED APPLICATION DATA

This application is a continuation-in-part of No. 60/284,163, filed Apr. 16, 2001.

### FIELD OF THE INVENTION

The present invention relates to exposing emulsion film and paper to impart a latent pattern thereto.

### BACKGROUND AND SUMMARY OF THE INVENTION

Digital watermarking is the science of encoding physical and electronic objects with hidden information, in such a manner that the data is essentially imperceptible to human perception, yet can be recovered by computer analysis.

The prior art teaches that emulsion media can be exposed—during manufacture and prior to end use—to impart a latent digital watermark pattern that will be manifested when the media is developed. Related to such technology are the disclosures of patents U.S. Pat. Nos. 5,752,152, 5,822,436, 5,832,119, 5,850,481, 5,859,920, 5,864,742, 5,919,730, 5,936,652, 6,111,954, 6,130,741, and allowed application Ser. No. 09/640,806. The present assignee's patent U.S. Pat. No. 6,122,403, and application Ser. No. 09/503,881, are illustrative of certain watermarking technologies.

The watermark pattern can serve various purposes. For example, it can serve as a copy-control signal—indicating to compliant reproduction equipment (e.g., photocopiers, kiosks) that an image found on the media should not be reproduced.

Alternatively, the watermark can serve to serialize the media for forensic, or copyright communication purposes. For example, the film can be serialized with a unique number that serves to identify the photographer who used the film.

More generally, the watermark can serve to associate an image with a store of related data. For example, an image watermark may contain an index value that serves to identify a database record specifying (a) the owner's name; (b) contact information; (c) license terms and conditions, (d) copyright date, (e) whether adult content is depicted, etc., etc. (The present assignee's MarcCentre service provides such functionality.) Related are so-called “connected content” applications, in which a watermark in one content object (e.g., an image) serves to link to a related content object (e.g., a web page devoted to the same topic). The watermark can literally encode an electronic address of the related content object, but more typically encodes an index value that identifies a database record containing that address information. application Ser. No. 09/571,422 details a number of connected-content applications and techniques.

In accordance with preferred embodiments of the present invention, apparatuses are provided to facilitate exposure of emulsion media with watermark patterns.

The foregoing and additional features and advantages of the invention will be more readily apparent from the following detailed description, which proceeds by reference to the accompanying drawings.

### BRIEF DESCRIPTION OF THE DRAWINGS

FIGS. 1 and 2 illustrate apparatuses according to different embodiments of the present invention for exposing emulsion media with watermark patterns.

### DETAILED DESCRIPTION

As film is being produced or packaged, the producer (or packager) can run the hard copy unexposed film through a machine that very lightly exposes the negative/film to a watermark. The film is spun and packaged as is normally done into the small black plastic canisters. Each roll has a unique watermark, or similarly each pack of six (or other number) rolls has a unique watermark. The photographer takes normal pictures but inherent in the negative is the originally exposed watermark. This mark can be monochromatic, or polychromatic.

Since the substrate is one entire length of unexposed film, there are no “frames” per se; these appear only after exposure through the camera lens. To expose a continuous strip of film with a watermark, a barrel-shaped object much like a motion picture film reel can be formed, which has a “projector” inside it. The top and bottom is enclosed, but the entire side is either open or enclosed in glass. The center of this canister has three “projectors” that are connected to a server. Each projector has a display view of 120 degrees. The number of projectors is irrelevant as long as they cover 360 degrees. As the film rolls by, the canister rolls at the same rate exposing the mark to the film. After enough film stock passes by to equal the 36 or 24 exposure roll, the watermark server moves to the next watermark and projects this new mark as the film stock passes. This interchange happens continuously until the number of watermarked rolls ordered is complete.

Alternatively, a source of watermark exposure illumination can be gated by a narrow slit next to which the film is run. As the film passes this slit, the illumination changes, effecting a progressive scanning of the watermark exposure on the film. (The exposure illumination can be a linear array of LEDs or other illumination source that extends in at least one dimension.)

Still another approach is to employ a light table that is the length of the typical 36 exposure roll can be used—it can extend to whatever the maximum length of film would be inside a canister. The table width needs to be no more that the film width. Machinery grabs the first few sprockets of the film length and pulls it to lay on top of the entire length of the table. A projector on the inside of the light table is connected to the watermark server, and it projects the mark along the length of the table. Here the moving film might pause momentarily while the exposure is made, whereas the earlier arrangements generally employ continuous film movement.

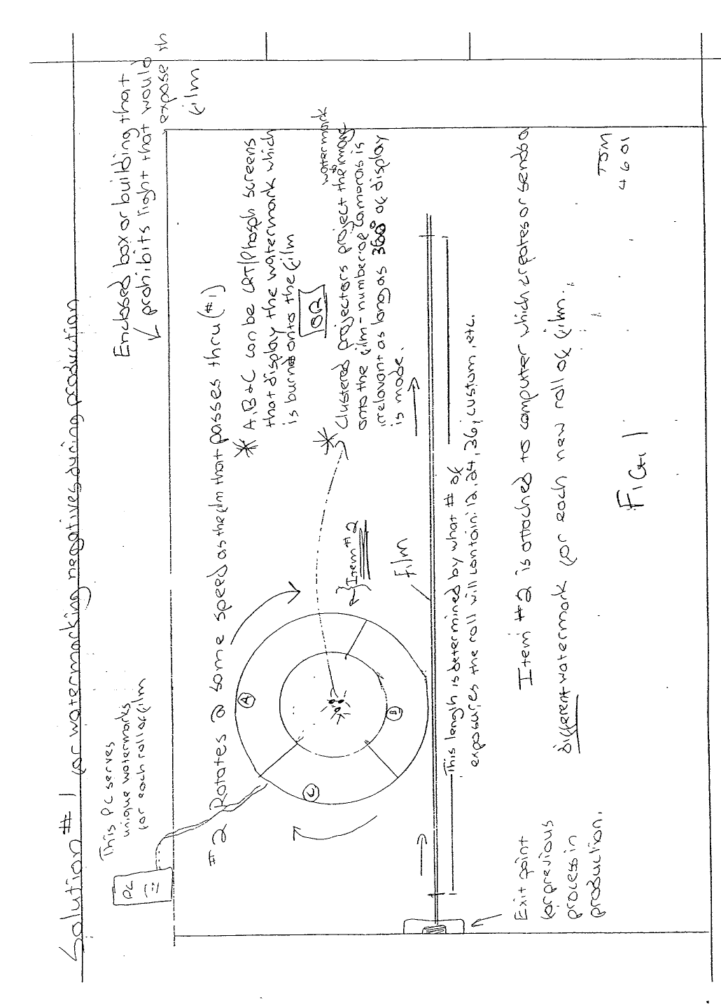

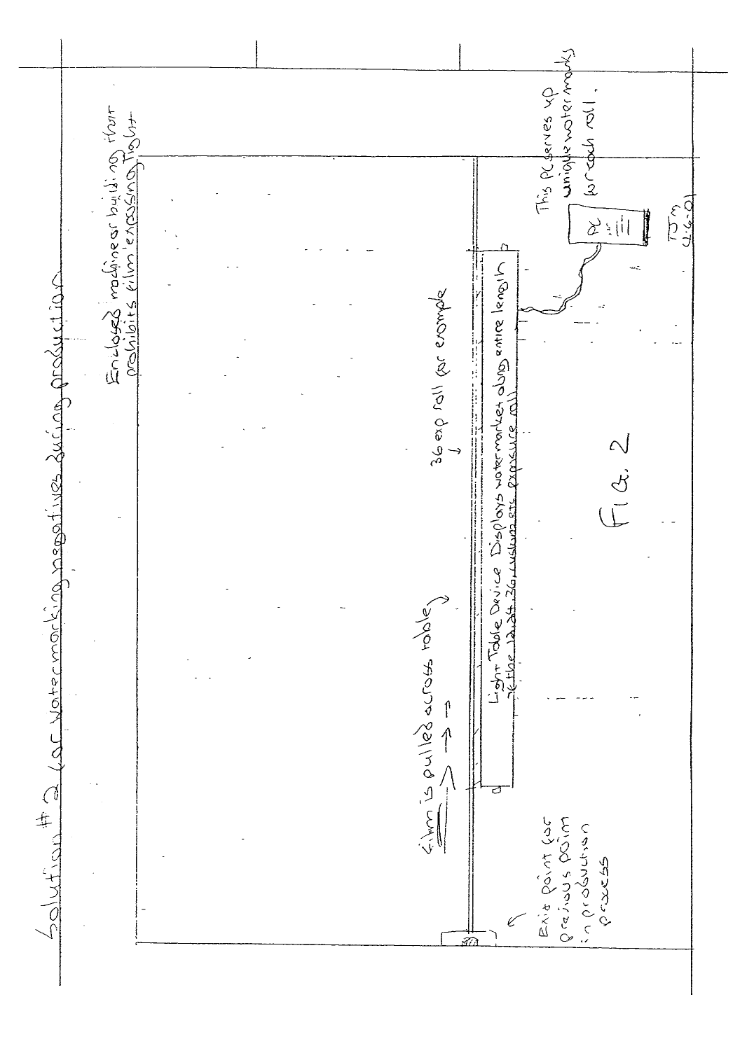

Such arrangements are shown in FIGS. 1 and 2.

The film's canister can be marked with the watermark ID listed on it (or watermarked onto the canister or its packaging). The consumer can thereafter go to the Digimarc MediaBridge registration web site (or other such database server) and enter in the canister ID number—or simply holds the uniquely watermarked canister up to the camera. Once the roll has been so-identified to the Grand Central database, the user enters meta data that is to be associated with the film—including the owner's name, conventional and/or email address (to which finished prints can be delivered), etc. If the film has already been exposed, the meta data can include descriptors about the imagery. The film watermark persists in hardcopy and electronic pictures from this film, and can be similarly used to later recall and use the associated meta data.

Another option is to provide a camera with a fixed or removable optical filter (like a polarizer) that is patterned to impart a watermark to the subject imaged through such a filter (e.g., the filter causes the luminance to slightly, locally, vary across the field of view, embedding a watermark signal corresponding to that particular filter). Different photographers, or cameras, can have filters that encode different watermarks in the resulting imagery. (It will be recognized that this technique is applicable both with film and digital cameras.) Again, the embedded watermark can be used in a digital asset management system, serving to associate with the picture a store of related information.

The foregoing techniques can be applied with photographic paper.

On techniques such as the foregoing, in which watermark information is present from the instant an image is captured, a great variety of security systems can be based. For example, every camera can tag its captured images with a mark unique to that camera. If a camera is stolen, photo-processors can look for the watermark of that camera in film they develop and pictures they reprint, discouraging theft of camera equipment.

To provide a comprehensive disclosure without unduly lengthening this specification, the patents and applications cited above are incorporated herein by reference.

Having described and illustrated the subject technologies with reference to illustrative embodiments, it should be recognized that the invention is not so limited. Rather, we claim as our invention all such embodiments as come within the scope and spirit of the following, claims, and equivalents thereto.

We claim:

1. An apparatus for pre-exposing a roll of emulsion media with a latent pattern prior to end-use by a consumer of said media, the apparatus comprising a barrel-shaped member having optical projection elements therein, the apparatus serving to roll the member relative to the media to expose the media in accordance with a pattern provided to said optical projection elements.

2. The apparatus of claim 1 in which the latent pattern forms a steganographic watermark.

3. The apparatus of claim 2 in which the steganographic watermark represents plural bits of information.

4. The apparatus of claim 1 in which the pattern serves as a copy control signal that indicates, to compliant equipment, that an image on said media should not be reproduced.

5. The apparatus of claim 1 in which the pattern spans the media, rather than being found only in one portion thereof, thereby allowing detection of said pattern from first and second non-overlapping portions of said media.

6. The apparatus of claim 1 in which the pattern is periodic.

7. The apparatus of claim 1 in which the pattern comprises a regular array of elements.

8. The apparatus of claim 1 in which the pattern is monochromatic.

9. The apparatus of claim 1 in which the pattern is polychromatic.

10. The apparatus of claim 1 in which the optical projection elements comprise lenses disposed within said member.

11. The apparatus of claim 1 in which the optical projection elements comprise optical display screens.

12. An apparatus for pre-exposing a roll of emulsion media with a latent pattern prior to end-use by a consumer of said media, the apparatus comprising a structure defining a slit that is moved relative to the media, the slit providing therethrough illumination from a substantially one-dimensional light source that is driven to produce a changing pattern of illumination, wherein as the media moves relative to the slit, it is exposed by the changing pattern of illumination provided from said light source through said slit.

13. The apparatus of claim 12 in which the latent pattern forms a steganographic watermark.

14. The apparatus of claim 13 in which the steganographic watermark represents plural bits of information.

15. The apparatus of claim 12 in which the pattern serves as a copy control signal that indicates, to compliant equipment, that an image on said media should not be reproduced.

16. The apparatus of claim 12 in which the pattern spans the media, rather than being found only in one portion thereof, thereby allowing detection of said pattern from first and second non-overlapping portions of said media.

17. An apparatus for pre-exposing emulsion media with a latent pattern prior to end-use by a consumer of said media, the apparatus comprising a light table from which a pattern of light emanates, and against which emulsion media can be laid to expose said media with said pattern, the pattern being substantially indiscernible by a human viewer of the media after developing, but being discernible from computer analysis of optical scan data corresponding to said media after developing.

18. The apparatus of claim 17 in which the pattern forms a steganographic watermark representing plural bits of information.

19. The apparatus of claim 17 in which the pattern serves as a copy control signal that indicates, to compliant equipment, that an image on said media should not be reproduced.

20. The apparatus of claim 17 in which the pattern spans the media, rather than being found only in one portion thereof, thereby allowing detection of said pattern from first and second non-overlapping portions of said media.
